(19) United States
(12) Patent Application Publication
(10) Pub. No.: US 2009/0183151 A1
(43) Pub. Date: Jul. 16, 2009

(54) Obtaining Software for a Handheld Device

(76) Inventors: Sam Gharabally, San Francisco, CA (US); Michael Kuohao Chu, Cupertino, CA (US); Hiro Mitsuji, San Francisco, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/186,442

(22) Filed: Aug. 5, 2008

Related U.S. Application Data
(60) Provisional application No. 61/021,300, filed on Jan. 15, 2008.

(51) Int. Cl. G06F 9/445; G06Q 30/00

(52) U.S. Cl. 717/178

(57) ABSTRACT

Techniques for improved installation of software on handheld devices. In one embodiment, a handheld device is coupled with a computer that has a client software application. The client software application can support installing software applications onto the handheld device. The client software application can determine if the handheld device is in need of, or already has, one or more particular software applications installed on the handheld device. The client application software can then obtain the particular software applications from a remote server and then transfer the particular software applications to the handheld device. Advantageously, a user can automatically be made aware of the particular software applications that it may need. In one implementation, a user of the handheld device or the computer can purchase the particular software applications.

### CROSS-REFERENCE TO RELATED APPLICATION

This application claims priority to U.S. Provisional Patent Application No. 61/021,300, filed Jan. 15, 2008, entitled “Obtaining Software for a Handheld Device”, which is herein incorporated herein by reference.

### BACKGROUND OF THE INVENTION

1. Field of the Invention

The invention pertains to obtaining software applications for a handheld device and, more particularly, to purchasing, downloading, and/or installing software applications for a handheld device.

2. Description of the Related Art

Handheld computing devices are often updated and/or managed using some form of connection between the handheld device and other computing device, such a personal computer. The connection between a handheld device and a personal computer is achieved using a variety of connection types, including various wired and/or wireless connections. Typically, when a handheld device is connected to a personal computer, information (e.g., contact lists, email, etc.) is ‘synched’ between the handheld device and the personal computer.

In addition, it is also known to use a personal computer to install software onto handheld devices. There are several reasons to use a personal computer to install software onto a handheld device. One reason is because many handheld devices do not have the capability to download and/or install software directly. Another reason is that it is often more efficient to use a personal computer to facilitate the installation or updating of handheld software applications since handheld devices often have limited capabilities to run software program installation applications.

Unfortunately, however, as handheld devices and software applications continue to proliferate, it becomes more and more difficult to find useful and/or appropriate handheld software applications. Hence, there is a demand for new ways to locate and install software applications on handheld devices.

### SUMMARY OF THE INVENTION

The invention pertains to techniques for improved installation of software on handheld devices. In one embodiment, a handheld device is coupled (e.g., via a cable or a wireless connection) with a computer that has a client software application. The client software application can support installing software applications onto the handheld device. The client software application can determine if the handheld device is in need of, or already has, one or more particular software applications installed on the handheld device. The client application software can then obtain the particular software applications from a remote server and then transfer the particular software applications to the handheld device. Advantageously, a user can automatically be made aware of the particular software applications that it may need. In one implementation, a user of the handheld device or the computer can purchase the particular software applications.

In one embodiment, a client software application capable of installing software for a handheld device can check for connectivity of the client computer to the handheld device. The client software application can then identify if the handheld device is in need of new software applications or, alternately, software updates to software applications that are currently installed on the handheld device. If the handheld device is in need of the particular software applications or updates, the client software application can present a user (i.e., the user of the handheld device) with an option to purchase the particular software applications or updates. The client software application can then obtain the particular software applications or updates from a remote server and then transfer the particular software applications or updates to the handheld device. In one implementation, the client software application can also support synchronizing data between the client computer and the handheld device.

In another embodiment of the invention, a client software application capable of installing software applications to a handheld device can be implemented as a client software application that runs on the handheld device. In this embodiment, the client software application can communicate with a remote server to obtain new software applications for the handheld device directly, without need to be connected to a separate client computer.

The invention can be implemented in numerous ways, including as a method, system, device, or apparatus (including a computer readable medium or a graphical user interface). Several embodiments of the invention are discussed below.

As a computer-implemented method for providing software applications to a handheld device, one embodiment of the invention can, for example, including at least: determining connectivity of the handheld device to a client application, the client application being executed on a computer remotely from the handheld device; determining whether the handheld device may install one or more software applications capable of running on a handheld device; and installing on the handheld device the determined one or more software applications onto the handheld device.

As a computer-implemented method for providing software applications to a handheld device, another embodiment of the invention can, for example, include at least: determining if a particular handheld device is connected to a client computer: accessing the particular handheld device via a client application operating on the client computer: determining, via the client application, whether one or more software applications are available for the particular handheld device; presenting a query to the user of the particular handheld device as to whether to install one or more available software applications on the handheld device; receiving a response to the query; and installing at least one of the one or more software applications based on the response to the query.

As a computer implemented method for determining whether one or more software applications are available for installation on a handheld device that has been connected to a client computer, one embodiment of the invention can, for example, include at least: determining, using a client application running on a client computer, if a handheld device has been activated for use; if the handheld device has been activated for use, receiving a purchase request for the one or more available software applications; processing the purchase request for one or more of the one or more available software applications; and installing the one or more purchased software applications on the activated a handheld device.

As a system for installing software on a handheld device, one embodiment of the invention can, for example, include at least: a client computer coupled to the handheld device; and a software application running on the client computer. The software application running on the client computer can be configured to determine if one or more software applications are available for installation on the handheld device, and install, on the handheld device, the one or more software applications determined to be available for the handheld device.

As a handheld device one embodiment of the invention can, for example, include at least preinstalled software applications that cannot be operated on the handheld device until the handheld device has been activated and be preinstalled software applications have been purchased.

As a computer readable medium including at least executable computer program code tangibly stored therein for providing software applications to a handheld device, one embodiment of the invention can, for example, include at least: computer program code for determining connectivity of the handheld device to a client application, the client application being executed on a computer remotely from the handheld device; computer program code for determining whether the handheld device may install one or more software applications capable of running on a handheld device; and computer program code for installing on the handheld device the determined one or more software applications onto the handheld device.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a system for installing software applications on a handheld device according to one embodiment of the invention.

FIG. 2 is a flow diagram of a handheld software installation process according to one embodiment of the invention.

FIG. 3 is a flow diagram of a handheld software installation process according to another embodiment of the invention.

FIG. 4 is a state diagram of a user account state diagram according to one embodiment of the invention.

FIG. 5 is a block diagram of a user interaction according to one embodiment of the invention.

FIG. 6 depicts an exemplary software bundle installation process according to one embodiment of the invention.

### DETAILED DESCRIPTION OF THE INVENTION

The invention pertains to techniques for improved installation of software on handheld devices. In one embodiment, a handheld device is coupled (e.g., via a cable or a wireless connection) with a computer that has a client software application. The client software application can support installing software applications onto the handheld device. The client software application can determine if the handheld device is in need of, or already has, one or more particular software applications installed on the handheld device. The client application software can then obtain the particular software applications from a remote server and then transfer the particular software applications to the handheld device. Advantageously, a user can automatically be made aware of the particular software applications that it may need. In one implementation, a user of the handheld device or the computer can purchase the particular software applications.

In one embodiment, a client software application capable of installing software for a handheld device can check for connectivity of the client computer to the handheld device. The client software application can then identify if the handheld device is in need of new software applications or, alternately, software updates to software applications that are currently installed on the handheld device. If the handheld device is in need of the particular software applications or updates, the client software application can present a user (i.e., the user of the handheld device) with an option to purchase the particular software applications or updates. The client software application can then obtain the particular software applications or updates from a remote server and then transfer the particular software applications or updates to the handheld device. In one implementation, the client software application can also support synchronizing data between the client computer and the handheld device.

In another embodiment of the invention, a client software application capable of installing software applications to a handheld device can be implemented as a client software application that runs on the handheld device. In this embodiment, the client software application can communicate with a remote server to obtain new software applications for the handheld device directly, without need to be connected to a separate client computer.

One particular embodiment of the invention provides a bundle of software applications via a client application (e.g., iTunes™) so users who purchased a handheld device (e.g., an iPod Touch™) prior to a particular date are able to purchase a software bundle for their device. More particularly, the handheld device can be an iPod Touch™ device available from Apple Inc., and the client application can be iTunes™ application program, which can be used manage media content on iPod™ type devices. In this example, a user plugs in the iPod Touch™ device to a client computer running the iTunes™ application program (typically by using a USB cable or FireWire cable) and is directed to an information page (e.g., webpage) that describes a software bundle available for the iPod Touch™ device. The user can purchase the described software bundle. If purchased, the software bundle can then be downloaded to the client computer for installation to the iPod Touch™ device. Alternately, in this particular embodiment, a visitor to the iTunes™ online media store who has an iPod Touch™ currently connected to his computer can be presented with an option on the iTunes™ online media store page offering to sell a software bundle for his iPod Touch™ so long as the currently connected iPod Touch™ does not have the software bundle already installed upon it. The user can be presented with an option to be reminded to purchase the software bundle later or can opt to not purchase the software bundle and not be reminded again. Once the user has purchased the software bundle, that user will not be presented with the option to purchase the software bundle again.

In general, a handheld device can include small form factor devices such as a digital music player, a digital video player, a mobile phone, a PDA (Personal Data Assistant), mobile phone, or any other handheld device that may have software applications installed. Also, software applications are application programs, which excludes operating system programs.

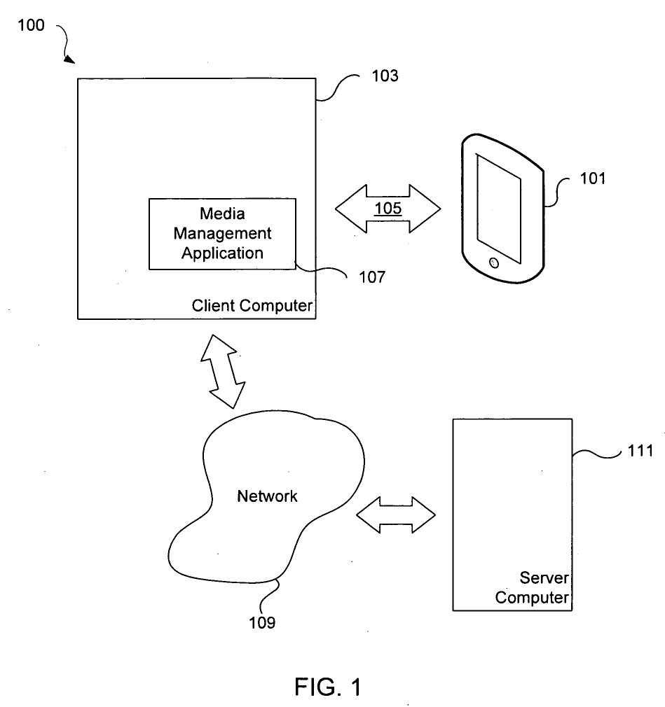

FIG. 1 is a block diagram of a system 100 for installing software applications on a handheld device according to one embodiment of the invention. The system 100 includes a handheld device 101 coupled to a client computer 103 via a cable 105. While a cable 105 is shown in FIG. 1, it is understood that any conventional method of communication between the handheld device 101 and the client computer 103, including various wired and wireless forms of communication can be used. For instance, the handheld device 101 can be coupled to the client computer 103 using a USB connector, a FireWire connector, a WiFi connection, or an infrared connection. A client application 107 is depicted running on the client computer 103. The client application 107, for example a media management application (e.g., iTunes™ media application available from Apple Inc.), can be used to manage media stored on the handheld device 101, to set user preferences for the handheld device 101, and to install software on the handheld device 101, among other things.

The client computer 103 can connect to a server computer 111 over a network 109, for example the Internet. The client computer 103 can be connected to the network either by a cable, for example an Ethernet cable or by wireless network connection. The client computer 103 can connect to the server computer 111 to download software and/or other files to transfer to the handheld device 101. In one embodiment, the client application 107 can interact with the server computer 111 by first logging onto a user account. The user account can be used for a wide variety of purposes, including, specifically, registering or activating the handheld device 101 and managing the handheld device 101.

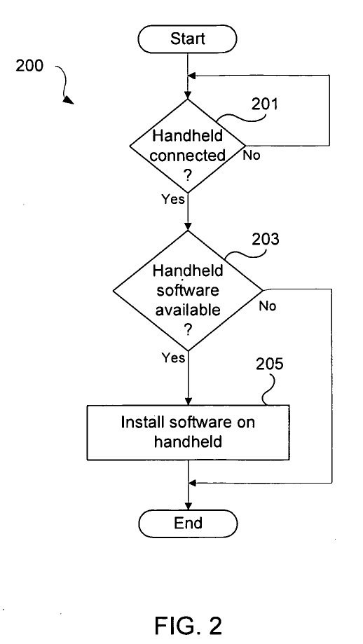

FIG. 2 is a flow diagram of a handheld software installation process 200 according to one embodiment of the invention. The handheld software installation process 200 can be implemented, for example, using the system 100 of FIG. 1.

The handheld software installation process 200 begins with a decision 201 which determines if a handheld device is connected to a client computer. If decision 201 determines that a handheld device is connected to the client computer, then the handheld software installation process continues to decision 203. If decision 201 determines that no handheld devices are connected to the client computer, then the handheld software installation process 200 idles until such a time as a handheld device is connected. Next, decision 203 determines if software is available for the handheld device that is connected to the client computer. If so, then available software is installed 205 to the handheld device and the handheld software installation process 200 ends. If, on the other hand, decision 203 determines that no software is available for the handheld device then the handheld software installation process 200 ends. The determination 203 of whether software is available for the handheld device can be based on one or more of a wide variety of factors. For example, one factor is whether the handheld device has been activated (i.e., enabled or registered for use). As another example, another factor is which version of the handheld device operating system is currently running on the handheld device. The installation 205 of software on the handheld device can include one or more of several intermediate steps including prompting the user to agree to a license or terms of use agreement, prompting the user to purchase one or more available software programs, bundles or packages, downloading the available software programs, and transferring (e.g., via a syncing operation) the available software programs to the handheld device.

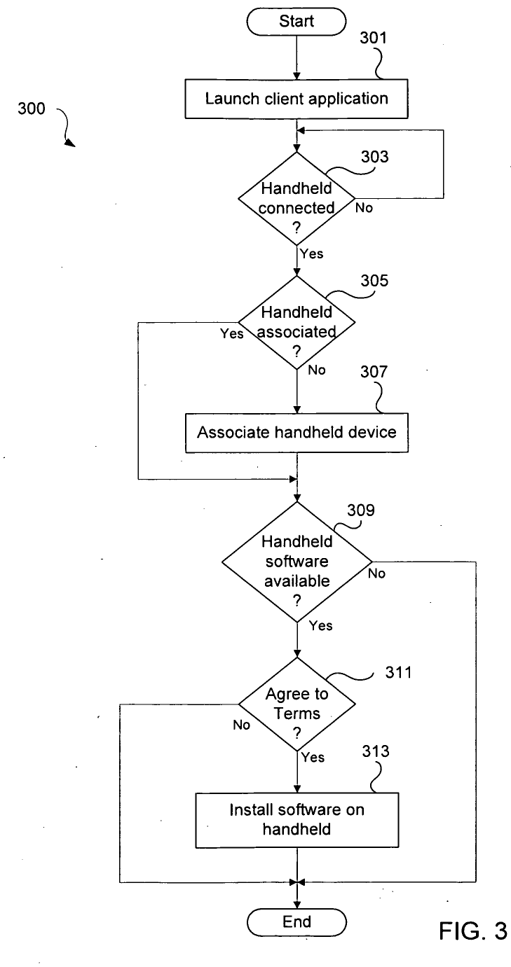

FIG. 3 is a flow diagram of a handheld software installation process 300 according to another embodiment of the invention. A handheld software installation process 300 can be implemented, for example, using the system 100 of FIG. 1.

The handheld software installation process 300 starts by launching 301 a client application that is capable of installing software onto a handheld device on a client computer. One example of a client application that is capable of installing software onto a handheld device is iTunes which is capable of installing software onto iPods and iPhones. Next, a decision 303 determines if a handheld device has been connected to the client computer, for example by means of a cable. If decision 303 determines that a handheld device is connected to the client computer, then a decision 305 determines if the connected handheld device is associated with the client application. For example, the connected handheld device can be associated with the client application if the connected handheld device has been synchronized to a media library on the client computer or if the handheld device has been registered using the client application. If decision 305 determines that the handheld device is not associated with the client application, the handheld device is associated 307 with the client application, subject to the handheld device user's (owner's) approval of the association 307 between the handheld device and the client application. Of course, the user can elect not to associate the handheld device with the client application, in which case the handheld software installation process 300 can terminate (not shown).

Returning to decision 305, if the handheld device is associated with the client application, then the handheld software installation process 300 continues to decision 309, which determines if software is available for the associated handheld device. If decision 309 determines that software is available for installation on the associated handheld device, then the handheld software installation process 300 continues to decision 311 which detects if the user of the handheld device has agreed to the terms associated with the installation of the available software onto the handheld device. The terms associated with the installation of available software onto the handheld device include, for example, determining whether a user has purchased some or all of the available software and/or agreed to the terms of use that the user is required to agree to in order to install software on the handheld device.

Returning to decision 309, if decision 309 determines that no software is available for installation on the associated handheld device, then the handheld software installation process 300 ends. If, on the other hand, decision 309 determines that no software is available for installation on the handheld device, then the handheld software installation process 300 ends.

Returning to decision 311, if decision 311 determines that the user has not agreed to the terms associated with the installation of the available software onto the handheld device, then the handheld software installation process 300 ends. On the other hand, if decision 311 determines that the user has agreed to the terms associated with the installation of the available software onto the handheld device, then the software is installed 313 on to the handheld device and the handheld software installation process 300 ends. The installation 313 can include, for example, downloading the software from a remote server as well as the act of installing the software onto the handheld device. If, on the other hand, decision 311 determines that the user has not agreed to the terms associated with the installation of the software, then the handheld software installation process 300 ends without installing the software.

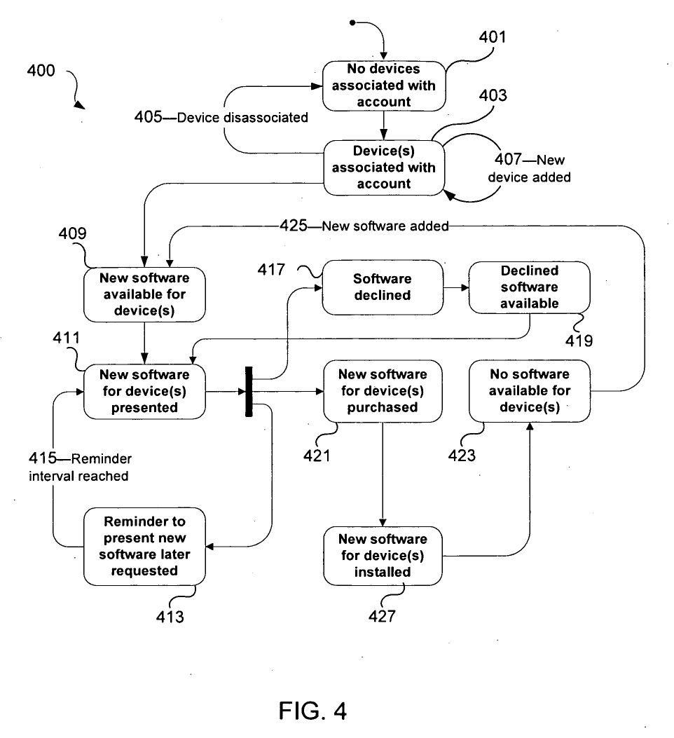

FIG. 4 is a state diagram of a user account state diagram 400 according to one embodiment of the invention. The user account can be used to keep track of the status of the installation of one or more software applications onto a handheld device. The user account can be associated with one or more handheld devices. In one embodiment, associating a user account with a handheld device can only be accomplished when a handheld device has been activated and a user account has been created. Further, the user account can be created and managed within an application (e.g., a media management application) that is also used to manage media content or other files that can be stored on an associated handheld device. In a specific example, the iTunes™ software application can associate one or more portable media players (e.g., iPod™, iPhone™) with specific iTunes™ user accounts.

The user account state diagram 400 begins in an initial state 401 wherein no devices are associated with a user account. The user account state 401 can, for example, be entered upon first installing a media management application, before any account information has been entered or before a user has logged onto a user account and associated a media player or other handheld device. User account state 403 is entered when one or more handheld devices have been associated with a user account. For example, a serial number could be entered into an account management page. In another example, a handheld device can be connected to a client computer upon which a client application such as a media management application is installed and thereafter detected as a new device. Conversely, a state transition 405 can occur when a device is somehow disassociated with the account, for example if it becomes associated with a new account. In addition, a state transition 407 can occur if another device becomes associated with the account.

User account state 409 is entered if new (or updated) software is available for an associated device. New software could become available at any time after the association of a handheld device with a user account. In one embodiment, a handheld device can be manufactured and have preinstalled software installed at the time of the manufacture. Later, when the handheld device is connected to a computer, it can be registered and associated with a user account upon which time a check can be made to see if new or updated software is available to replace or augment the preinstalled software.

The user account state will remain in state 409 and up until the point where the new software has been presented to the account holder, whereupon the user account state enters state 411. In one implementation, three user account states can be reached from user account state 411. In the user account state 413, the user (e.g., account holder) has elected to be reminded later to install any available software on a handheld device. This can be implemented, for example, as a “remind me later” button that is activated by the user if he does not currently want to update software on his device. The time interval between the user selection to be reminded later and the occurrence of the reminder can be referred to as a reminder interval. When the reminder interval has passed a user account, state 411 is reentered and the new software is presented again to the user. In one embodiment of the invention, a user may choose to be reminded later a finite number of times before that user account is a treated as if a user has declined to install the software and the user account state becomes user account state 417. Alternately, user account state 417 is reached from user account state 411 if the user explicitly declines to install the available software onto his handheld device. User account state 421 is reached from user account state 411 if the user purchases or, in the case of free software, agrees to install the available software onto his handheld device. If the user has implicitly or explicitly declined to install available software, the user account state becomes user account state 419, wherein the account is marked as being associated with a device with out of date or declined software. If a user later wishes to install the declined software (for instance by interacting with a handheld device preferences page on the client computer), then the user account state can return to user account state 411 and the available software can be presented again to the user.

Once user account state 421 has been reached, the software can be installed and the user account state can be updated to user account state 427. If, for some reason, user account state 427 cannot be reached, for example if the handheld device is no longer connected, then the user account state remains in state 421 until such a time as a software can be installed at user account state 427. After successful software installation, the user account state can advance to the user account state 423.

User account state will remain in user account state 423 for that particular device until such a time as new software becomes available, which will trigger state transition 425 and advance the user account state to user account state 409. Note that user account states 403-423 can occur for any number of devices. For example, if the user has two devices associated with a user account, a user account states for each device do not necessarily have to be the same. Thus, in this example, one device may have up-to-date software while another may be awaiting the user's decision to install software.

The user account can be associated with one or more handheld devices and be used to manage files and media on the handheld devices. In one embodiment of the invention, when a handheld device is connected to a client computer upon which a client software application capable of managing handheld devices is operating, the handheld device can become associated with an account that is managed using the client software application.

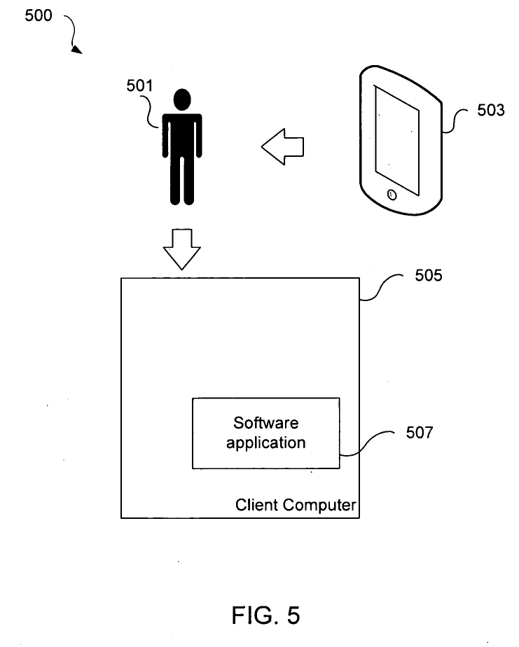

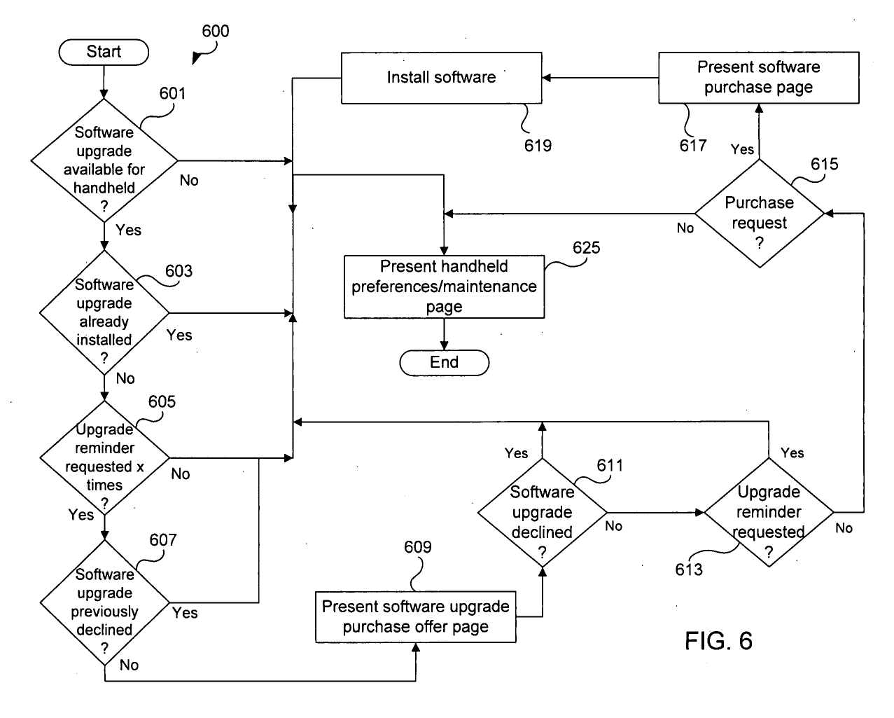

One implementation of the above exemplary embodiment of the user account state diagram 400 illustrated in FIG. 4 is described below with reference to FIGS. 5 and 6.

FIG. 5 is a block diagram of a user interaction 500 according to one embodiment of the invention. The user interaction 500 depicts a user 501 connecting a handheld device 503 (e.g., iPod Touch) to a client computer 505. A software application 507 (e.g., iTunes) running on the client computer 505 interacts with the handheld device 503 in order to determine whether one or more software applications are available for the handheld device 503. In addition, the user 501 interacts with the software application 507 in order to log into a user account that will be used to associate the handheld device 503 with the software application 507. When the handheld device 503 is connected to the client computer 505, the handheld device 503 is referred to as a tethered handheld device. The software application 507 enables the user to make decisions as to whether to purchase and/or install one or more of the available software programs on the tethered handheld device. The software application 507 may also be implemented such that it can interact with one or more client computers over one or more computer networks (not shown), for example as described above in reference to FIG. 1. The interactions between the user 501 and the server computer through the software application 507 using the client computer 505 can include logging onto a user account as described above in reference to FIG. 1. Note that, in the description of FIG. 6 below, reference numbers 501-507 are directly referenced throughout without specifically referring back to FIG. 5.

The process by which the software application 507 determines whether or not to present the user with choices regarding the installation of software applications to a tethered handheld device 503 is detailed below in FIG. 6.

FIG. 6 depicts an exemplary software bundle installation process 600 according to one embodiment of the invention. The exemplary software bundle installation process 200 occurs, for example, when the user 501 tethers the handheld device 503 to the client computer 505. The exemplary software bundle installation process 600 begins with a decision 601 that determines whether the system software on the handheld device 503 is eligible for a software bundle upgrade. If decision 601 determines that the system software on a handheld device 503 is eligible for a software bundle upgrade, a decision 603 determines whether the handheld device 503 has already received the software bundle upgrade. If decision 603 determines that the handheld device 503 has not already received a software bundle upgrade, then the exemplary software bundle installation process 600 continues to decision 605 which determines if the user 501 has previously asked the software application 507 to remind the user to install the software bundle at a later time least x times (x can equal any integer, for example x=3). If not, the exemplary software bundle installation process 600 continues to a decision 607, which determines if the user has previously elected not to install the software bundle. If so, the exemplary software bundle installation process 600 directs 625 the user to a handheld device maintenance/preferences screen for the particular handheld device and the software bundle installation process 600 ends.

The handheld device maintenance/preferences screen is a screen that appears each time a handheld device 503 is connected to the client computer 505. The handheld device maintenance/preferences screen allows the user 501 to manage media content and handheld device behavior preferences for any handheld device 503 that is connected to the client computer 505. One example of a handheld device maintenance/preferences screen is an iTunes™ device summary/device preferences screen that can be accessed from iTunes whenever an iPod™, iPhone™, or iPod Touch™ is connected to a computer running iTunes™. Returning to decision 601, if decision 601 determines that the system software on the handheld device 503 is not eligible for a software bundle upgrade, then the software bundle installation process 600 directs 625 the user to a handheld device maintenance/preferences screen for the particular handheld device and the software bundle installation process 600 ends.

Returning to decision 603, if decision 603 determines that the handheld device 503 has already received the software bundle upgrade then, they exemplary software bundle installation process 600 directs 625 the user to the handheld device maintenance/preferences screen for the particular handheld device and the software bundle installation process 600 ends.

Returning to decision 605, if decision 605 determines that the user 501 has previously asked to be reminded to install the software bundle and at least three times, then the software bundle installation process 600 directs 625 the user 501 to the handheld device maintenance/preferences screen for the particular handheld device. Here, it is assumed that the user does not wish to be reminded any more times to install the recommended software bundle and the software bundle installation process 600 ends.

Returning to decision 607, if decision 607 determines that the user 501 has not previously elected not to install the software bundle, then the software bundle installation process 600 directs 609 the user to an information page (e.g., webpage) offering to install the software bundle. Next, a decision 611 determines whether the user 501 has elected not to install the software bundle. If decision 611 determines that the user 501 has elected not to install the software bundle, then the software bundle installation process 600 directs 625 the user to a handheld device maintenance/preferences screen for the particular handheld device and the software bundle installation process 600 ends.

If, on the other hand, decision 611 does not detect that the user has declined to install the software bundle, then the software bundle installation process 600 continues to decision 613 which determines if the user 501 wishes to be reminded later to install the software bundle. If decision 613 determines that the user 501 wishes to be reminded later to install the software bundle, then the software bundle installation process 600 directs 625 the user 501 to a handheld device maintenance/preferences screen for the particular handheld device and the software bundle installation process 600 ends.

If, on the other hand, decision 613 determines that the user 501 does not want to be reminded later to install the software at idle, then the software bundle installation process 600 continues to decision 615, which determines if the user 501 wishes to purchase the software bundle. If not, the software bundle installation process 600 directs 625 the user 501 to a handheld device maintenance/preferences screen for the particular handheld device and the software bundle installation process 600 ends.

If, on the other hand, decision 615 determines that the user wishes to install the software bundle, then the software bundle installation process 600 directs 617 the user 501 to a software bundle installation page where the user is allowed to purchase the software bundle. Once the software bundle has been purchased, the software bundle installation process 600 installs 619 the purchased software on the handheld device and the user 501 is directed 625 to a handheld device maintenance/preferences screen for the particular handheld device and software bundle installation process 600 ends.

According to another embodiment, one or more software applications that have been acquired for a first handheld device as noted above may be subsequently moved, transferred or copied from the first handheld device to a second handheld device such that the one or more software applications may be executed on the second handheld device. The one or more software application may need to be registered or purchased, such as to same user account, before being usable on the second handheld device. The one or more software applications can be delivered to the second handheld device directly from the first handheld device (e.g., peer-to-peer transfer) or indirectly from a server (e.g., client-server transfer).

In another embodiment, a client software application for installing software to a handheld device is implemented as a client software application that runs on the handheld device. This in this embodiment, the client software application can communicate with a remote server to obtain new software for the handheld device directly, without the benefit being connected to a separate client computer.

In still another embodiment, software that is available to be installed on a handheld device is provided for no cost. Alternately, one or more software applications that are available to be installed on the handheld device can be offered for sale.

In yet another embodiment, previously un-activated software that has been preinstalled onto a handheld device can be activated. As in the above embodiments, a client software application can be configured to activate software that has been preinstalled onto the handheld device can run on a client computer. For example, the client software application can also be capable of performing a syncing operation with the handheld device. Alternately, the application to activate software that has been preinstalled onto the handheld device can be installed directly on the handheld device.

The various aspects, features, embodiments or implementations of the invention described above can be used alone or in various combinations.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, tactile or near-tactile input.

Implementations of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described is this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer implemented method of providing software applications to a handheld device, comprising:
determining connectivity of the handheld device to a client application, the client application being executed on a computer remotely from the handheld device;
determining whether the handheld device may install one or more software applications capable of running on a handheld device; and
installing on the handheld device the determined one or more software applications onto the handheld device.

2. The computer implemented method of claim 1, wherein said method further comprises:
receiving a purchase request for one or more of the determined one or more software applications.

3. The computer implemented method of claim 2, wherein the installing comprises installing the one or more determined one or more software applications on the handheld device that have been purchased.

4. The computer implemented method of claim 1, wherein the installing comprises activating the determined one or more software applications for use on the handheld device.

5. The computer-implemented method of claim 1, wherein the handheld device is connected to the client computer via a cable.

6. The computer implemented method of claim 1, wherein the handheld device is connected to the client computer wirelessly.

7. The computer implemented method of claim 1, wherein the determined one or more software applications are updated versions of software applications resident on the handheld device.

8. The computer implemented method of claim 1, wherein the handheld device utilizes an operating system capable of running software applications.

9. The computer implemented method of claim 1, wherein said method further comprises:
registering the one or more software applications specifically for the handheld device such that the one or more software applications may be executed on a second handheld device if the software application is copied to the second handheld device.

10. The computer implemented method of claim 1, wherein said method further comprises:
determining whether the handheld device has been activated for use.

11. The computer implemented method of claim 1, wherein the one or more software applications are application programs, wherein the application programs does not include operating system programs.

12. The computer implemented method of claim 1,
wherein the determining of whether the handheld device may install one or more software applications comprises:
determining a plurality of software applications that are designated for installation on the handheld device, and
wherein the installing on the handheld device of the determined one or more software applications onto the handheld device comprises:
installing the plurality of software applications onto the handheld device.

13. A computer implemented method for providing software applications to a handheld device, comprising:
determining if a particular handheld device is connected to a client computer:
accessing the particular handheld device via a client application operating on the client computer:
determining, via the client application, whether one or more software applications are available for the particular handheld device;
presenting a query to the user of the particular handheld device as to whether to install one or more available software applications on the handheld device;
receiving a response to the query; and
installing at least one of the one or more software applications based on the response to the query.

14. The computer implemented method of claim 13, wherein the querying of the user further comprises determining whether the user of the handheld device wants to purchase one or more software applications for installation on the handheld device.

15. The computer implemented method of claim 13, wherein the installation of the at least one or more software applications on the handheld device further comprises activating the at least one or more software applications for use on the handheld device.

16. A computer implemented method for determining whether one or more software applications are available for installation on a handheld device that has been connected to a client computer, said method comprising:
determining, using a client application running on a client computer, if a handheld device has been activated for use;
if the handheld device has been activated for use, receiving a purchase request for the one or more available software applications;
processing the purchase request for one or more of the one or more available software applications; and
installing the one or more purchased software applications on the activated a handheld device.

17. The computer implemented method of claim 16, wherein said method further comprises:
if the handheld device has not been activated for use, activating a handheld device for use prior to said processing and said installing.

18. A system for installing software on a handheld device, said system comprising:
a client computer coupled to the handheld device; and
a software application running on the client computer, the software application running on the client computer being configured to determine if one or more software applications are available for installation on the handheld device, and install, on the handheld device, the one or more software applications determined to be available for the handheld device.

19. The system of claim 18, wherein the software application running on the client computer queries a remote server in order to determine which software applications are available for installation on the handheld device.

20. The system of claim 19, wherein the software application running on the client computer is capable of processing a purchase request for the one or more software applications determined to be available for the handheld device.

21. The system of claim 20, wherein the software application running on the client computer can be connected to a plurality of handheld devices, and wherein the software application running on a client computer is further configured to independently determine for each of the plurality of handheld devices what software applications are available for each of the handheld devices, and wherein further the software application running on the client computer is further configured to purchase one or more software applications for installation on each of the plurality of handheld devices.

22. A handheld device comprising preinstalled software applications that cannot be operated on the handheld device until the handheld device has been activated and be preinstalled software applications have been purchased.

23. The handheld device of claim 22, wherein the handheld device can be activated by connecting it to a client computer running a client application capable of activating the handheld device.

24. A computer readable medium including at least executable computer program code tangibly stored therein for providing software applications to a handheld device, comprising:
computer program code for determining connectivity of the handheld device to a client application, the client application being executed on a computer remotely from the handheld device;
computer program code for determining whether the handheld device may install one or more software applications capable of running on a handheld device; and
computer program code for installing on the handheld device the determined one or more software applications onto the handheld device.
